(19) United States
(12) Patent Application Publication
(10) Pub. No.: US 2024/0273869 A1
(43) Pub. Date: Aug. 15, 2024

(54) DATA COLLECTION APPARATUS AND COMPUTER-IMPLEMENTED DATA COLLECTION METHOD USING SAME

(71) Applicant: Agency for Science, Technology and Research, Singapore (SG)

(72) Inventors: Jian Wei Jayce CHENG, Singapore (SG); Pawan KUMAR, Singapore (SG); Anas ABUTAHA, Singapore (SG); Daniil BASH, Singapore (SG); Tonio BUONASSISI, Singapore (SG); Kedar HIPPALGAONKAR, Singapore (SG)

(73) Assignee: Agency for Science, Technology and Research, Singapore (SG)

(21) Appl. No.: 18/569,997

(22) PCT Filed: Jun. 30, 2022
(86) PCT No.: PCT/SG2022/050456

§ 371 Date: Dec. 13, 2023

(30) Foreign Application Priority Data
Jul. 19, 2021 (SG) 10202107890Y

(51) Int. Cl. G06V 10/764; G01N 35/00; G06V 10/12; G06V 10/24; G06V 10/28; G06V 10/44; G06V 20/70

(52) U.S. Cl. CPC G06V 10/764; G01N 35/00732; G06V 10/12; G06V 10/24; G06V 10/28; G06V 10/44; G06V 20/70

(57) ABSTRACT

A data collection apparatus (10) and a computer-implemented data collection method (50) using the same are provided. The data collection apparatus (10) includes a first linear stage (12) and a second linear stage (14). A sample carriage (16) is attached to the first linear stage (12), the first linear stage (12) being operable to move the sample carriage (16) along a first axis. A probe carriage (18) is attached to the second linear stage (14), the second linear stage (14) being operable to move the probe carriage (18) along a second axis. A third linear stage (20) is attached to the probe carriage (18). In use, the third linear stage (20) is operable to receive a detachable characterisation probe (22) and to move the characterisation probe (22) along a third axis. A camera (24) is attached to the probe carriage (18). In use, the camera (24) is configured to capture an image of one or more samples on the sample carriage (16).

### FIELD OF THE INVENTION

The present invention relates in general to data collection and more particularly to a data collection apparatus and a computer-implemented data collection method using the same.

### BACKGROUND OF THE INVENTION

Large quantities of high-quality material property data are required to train machine learning models for accelerated materials discovery. Many samples with varied parameters are required to explore multidimensional parameter spaces.

High-throughput synthesis of many small volumes of samples is being used to generate the required large data sets of samples with varied parameters and their data integrity replicates to expand current knowledge of multidimensional parameter spaces.

However, high-throughput synthesis necessitates similarly high-throughput sample characterization, the latter of which is often a bottleneck in a materials discovery feedback loop.

Equipment capable of high-throughput sample characterization needs to be able to handle samples that do not always behave the same way, either due to intentional changes to material properties or from stochastic experimental variations.

However, conventional automated fault finding and defect inspection equipment in the semiconductor industry perform optical and electrical checks and measurements at predefined locations (testing points included in wafer layouts), aided by high spatial precision already present in wafer fabrication processes. Because wafer layouts include testing points, the equipment merely needs to align a probe to pre-defined pads. Accordingly, defect inspection merely involves detecting deviations from normal devices, rather than identifying novel structures.

Furthermore, conventional automated wafer measurement equipment takes measurements within narrow bounds of defect inspection, making them unsuitable for high-throughput characterization of samples which span large parameter space as conventional automated wafer measurement tools cannot span large parameter space. Different instruments that span a range of measurements are thus needed due to large parameter space.

Precise labelling and data parsing are also critical to providing clean and reliable data that can be used in subsequent machine learning processes.

In view of the foregoing, it would be desirable to provide a data collection apparatus and a computer-implemented data collection method using the same that addresses one or more of the above issues.

### SUMMARY OF THE INVENTION

Accordingly, in a first aspect, the present invention provides a data collection apparatus including a first linear stage and a second linear stage. A sample carriage is attached to the first linear stage, the first linear stage being operable to move the sample carriage along a first axis. A probe carriage is attached to the second linear stage, the second linear stage being operable to move the probe carriage along a second axis. A third linear stage is attached to the probe carriage. In use, the third linear stage is operable to receive a detachable characterisation probe and to move the characterisation probe along a third axis. A camera is attached to the probe carriage. In use, the camera is configured to capture an image of one or more samples on the sample carriage.

In a second aspect, the present invention provides a computer-implemented data collection method using the data collection apparatus according to the first aspect. The computer-implemented data collection method includes executing on one or more processors the steps of: capturing an image of the one or more samples using the camera; performing image recognition on the captured image of the one or more samples to identify different sample types and spatially index sample arrays; and performing measurements to characterise the one or more samples using the characterisation probe.

Other aspects and advantages of the invention will become apparent from the following detailed description, taken in conjunction with the accompanying drawings, illustrating by way of example the principles of the invention.

### BRIEF DESCRIPTION OF THE DRAWINGS

Embodiments of the invention will now be described, by way of example only, with reference to the accompanying drawings, in which:

FIG. 1 is a schematic diagram illustrating a data collection apparatus in accordance with an embodiment of the present invention;

FIG. 2 is a schematic flow diagram illustrating a computer-implemented data collection method using the data collection apparatus of FIG. 1;

FIGS. 3A through 3C are a series of photographs illustrating a series of steps in the computer-implemented data collection method of FIG. 2;

FIG. 4 is a schematic block diagram illustrating a computer system suitable for implementing the data collection method disclosed herein; and

FIGS. 5A through 5E are photographs illustrating image recognition performed on dropcast films on a quartz wafer.

### DETAILED DESCRIPTION OF EXEMPLARY EMBODIMENTS

The detailed description set forth below in connection with the appended drawings is intended as a description of presently preferred embodiments of the invention, and is not intended to represent the only forms in which the present invention may be practiced. It is to be understood that the same or equivalent functions may be accomplished by different embodiments that are intended to be encompassed within the scope of the invention.

The term “linear stage” as used herein refers to a platform that moves relative to a base.

The term “carriage” as used herein refers to a moving part of a machine that carries other parts into a required position. Accordingly, the term “sample carriage” as used herein refers to a moving part of a machine that carries one or more samples into a required position and the term “probe carriage” as used herein refers to a moving part of a machine that carries a probe into a required position.

The term “image recognition” as used herein refers to a digital image processing technique to identify specific objects in a digital image.

The term “image registration” as used herein refers to a digital image processing technique to align different images of the same scene.

The term “image thresholding” as used herein refers to a type of image segmentation where pixels of an image are changed to make the image easier to analyse.

The term “binarize” as used herein refers to a process of transforming data features of an entity into vectors of binary numbers. Accordingly, the term “binarized image” as used refers to an image represented by binary numbers.

The term “edge detection” as used herein refers to a digital image processing technique to find edges in a digital image.

The term “blob detection” as used herein refers to a digital image processing technique to identify connected pixels in a digital image that differ significantly in a particular property such as, for example, intensity, gradient and convolution with a certain kernel.

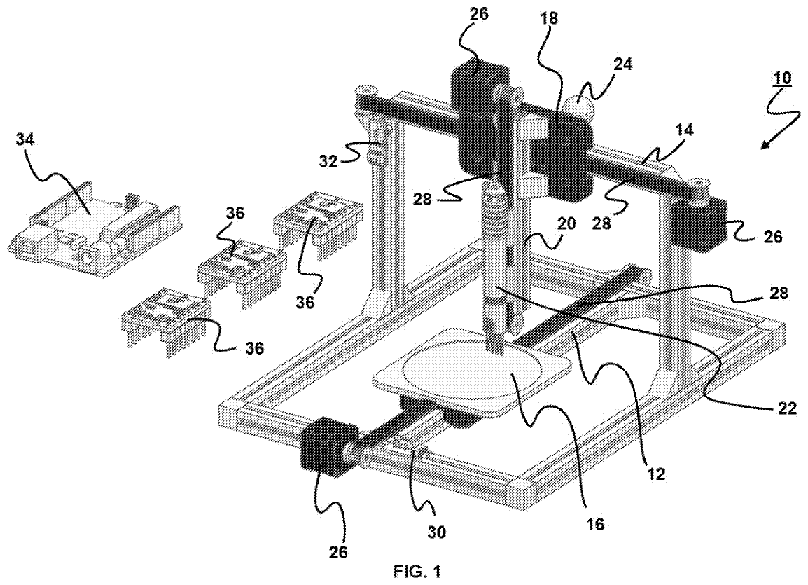

Referring now to FIG. 1, a data collection apparatus 10 is shown. The mechanical structure and control systems employed by the data collection apparatus 10 are shown in FIG. 1.

The data collection apparatus 10 includes a first linear stage 12 and a second linear stage 14. A sample carriage 16 attached to the first linear stage 12, the first linear stage 12 being operable to move the sample carriage 16 along a first axis. A probe carriage 18 is attached to the second linear stage 14, the second linear stage 14 being operable to move the probe carriage 18 along a second axis. A third linear stage 20 is attached to the probe carriage 18. In use, the third linear stage 20 is operable to receive a detachable characterisation probe 22 and to move the characterisation probe 22 along a third axis. A camera 24 is attached to the probe carriage 18. In use, the camera 24 is configured to capture an image of one or more samples on the sample carriage 16.

The first and second linear stages 12 and 14 provide translation in an x-y plane to move the characterisation probe 22 to different samples, while the characterisation probe 22 translates along a z-axis allowing for measurement and travel movements. The data collection apparatus 10 may thus be used to perform high-throughput characterization using various probe-based techniques that require 3-axis translation.

Each of the first, second and third linear stages 12, 14 and 20 may be driven by a microstepper motor 26.

Each of the first, second and third linear stages 12, 14 and 20 may include a plurality of linear bearings (not shown) coupled to the microstepper motor 26 by a pulley system 28. In one embodiment, the first, second and third linear stages 12, 14 and 20 and the characterisation probe 22 may be mounted on linear bearings coupled to the stepper motors 26 using pulley systems 28 that are similarly used in 3D printers. Advantageously, this allows for easier and rapid reconfiguration of the setup for different purposes.

The data collection apparatus 10 may also include first and second optical endstops 30 and 32 operable to determine real-time positions of the sample carriage 16 and the probe carriage 18 along the first and second axes, respectively. The optical endstops 30 and 32 allow the data collection apparatus 10 to feedback or update a real-time position. Advantageously, accurate position feedback facilitates and is critical for proper sample labelling.

The characterisation probe 22 may be an electrical probe such as, for example, a four-point probe or a Hall-effect probe, or an electrochemical probe such as, for example, an ion-selective electrode or a magnetic probe. Advantageously, the modular design of the z-axis translation allows for different probes 22 to be affixed to the third linear stage 20, making the data collection apparatus 10 highly customizable.

The camera 24 is part of a machine vision system and may be a Python-controlled webcam.

The data collection apparatus 10 may include a non-transitory computer-readable memory (not shown) storing computer program instructions executable by one or more computer processors 34 and 36 to perform operations for data collection. In one embodiment, linear motion on the 3-axes may be achieved using an Arduino UNO microcontroller 34 that sends commands to stepper motors 26 via DRV 8825 stepper motor driver chips or microstepping drivers 36. Each chip 36 may be capable of 1/32 microstepping, giving the probe position 50 μm spatial precision or spatial resolution.

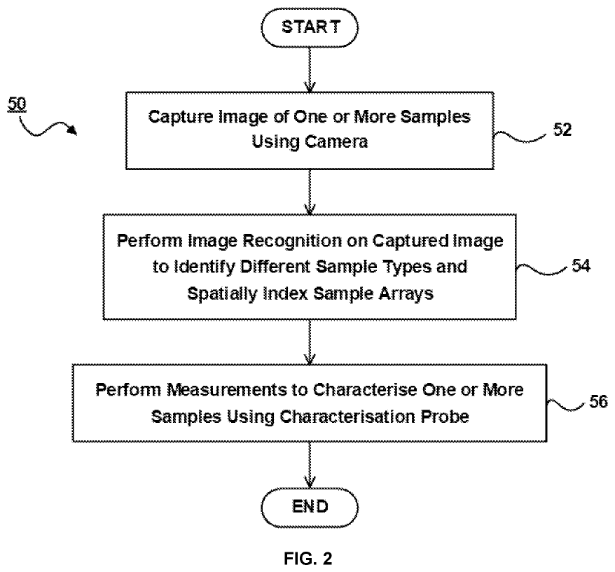

The operations for data collection performed when the computer program instructions stored in the non-transitory computer-readable memory are executed by the one or more computer processors 34 and 36 will now be described below with reference to FIG. 2.

Referring now to FIG. 2, a computer-implemented data collection method 50 using the data collection apparatus 10 of FIG. 1 is shown. The data collection method 50 may be executed on one or more processors 34 and 36 and may be implemented using Python script.

The data collection method 50 begins at step 52 by capturing an image of the one or more samples using the camera 24. In the embodiment shown, the camera 24 captures a top-down image of the one or more samples before measurements.

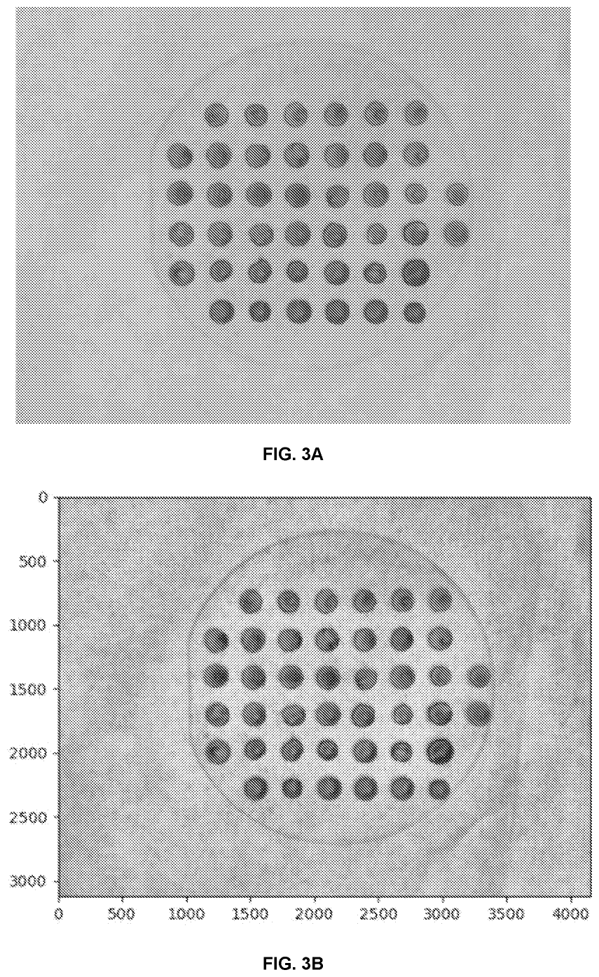

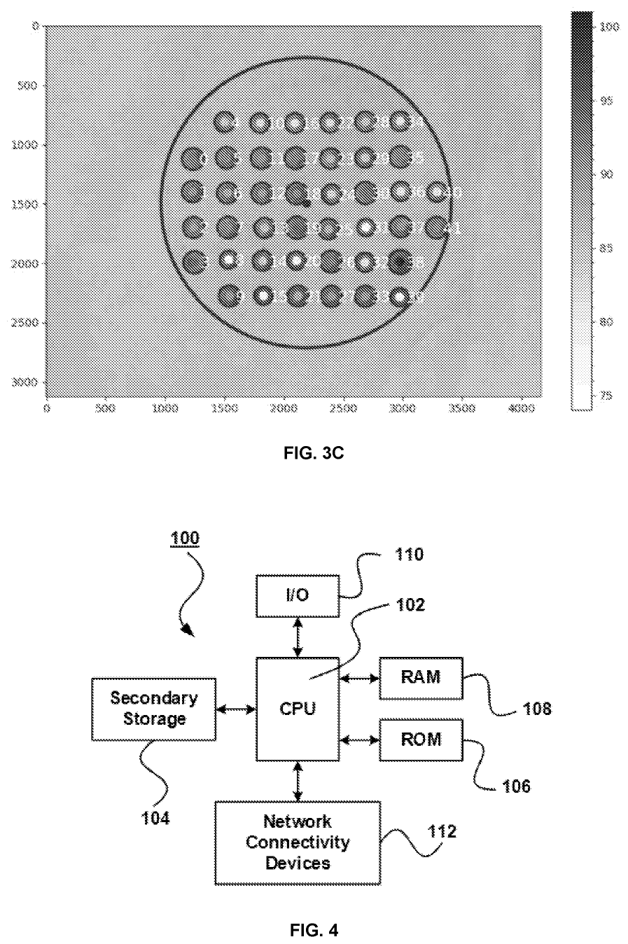

Referring now to FIG. 3A, a raw camera image captured by the camera 24 is shown.

Referring again to FIG. 2, image recognition is performed at step 54 on the captured image of the one or more samples to identify different sample types and spatially index sample arrays. The image recognition may be implemented using an Open-Source Computer Vision Library (OpenCV) package integrated into Python script.

The step of performing image recognition on the captured image may include performing image registration on the captured image by detecting a sample substrate. The sample substrate is received on the sample carriage 16 and may be a wafer, a microtiter plate (MTP), a vial rack or other two-dimensional (2D) array of a flat, horizontal surface.

Referring now to FIG. 3B, the step of performing image recognition on the captured image may also include performing image thresholding on the captured image to binarize the captured image as shown.

Referring now to FIG. 3C, the step of performing image recognition on the captured image may further include performing edge detection on the binarized image to identify sample boundaries as shown.

The step of performing image recognition on the captured image may also include performing blob detection on the binarized image to locate sample positions for subsequent measurements. Advantageously, blob detection is a particularly robust image recognition technique that is stable against shape translation and transformation, making it useful for finding irregular samples.

The located sample positions may be labelled as shown in FIG. 3C.

The droplet recognition process in the embodiment shown in FIGS. 3A through 3C may be implemented using Python script. The Python script may first perform image registration of the sample carriage 16 attached to the first linear stage 12 by detecting an edge of the substrate, for example, a quartz wafer edge. The Python script may then use thresholding, edge detection and finally blob detection to find sample positions for subsequent measurement.

Referring again to FIG. 2, measurements are then performed at step 56 to characterise the one or more samples using the characterisation probe 22. In an embodiment where the characterisation probe 22 is a four-point probe linked to a Keithley 2450 Sourcemeter, the four-point probe may be controlled using the National Instruments VISA package and the Python package PyVISA.

Advantageously, incorporation of the camera 24 and image recognition scripts embedded into the data collection apparatus 10 allow automatic data collection with different types of wafer-based or liquid-based samples. Modularity in both software and hardware makes the data collection apparatus 10 highly reconfigurable for different purposes using different probe techniques and on different sample types. Furthermore, implementation of low-level computer vision intelligence in the image recognition system allows the data collection apparatus 10 to deal with many different types of samples and errors.

Referring now to FIG. 4, a computer system 100 suitable for implementing the data collection method 50 is shown. The computer system 100 includes a processor 102 (which may be referred to as a central processor unit or CPU) that is in communication with memory devices including secondary storage 104, read only memory (ROM) 106, random access memory (RAM) 108, input/output (I/O) devices 110, and network connectivity devices 112. The processor 102 may be implemented as one or more CPU chips.

It is understood that by programming and/or loading executable instructions onto the computer system 100, at least one of the CPU 102, the RAM 108, and the ROM 106 are changed, transforming the computer system 100 in part into a particular machine or apparatus having the novel functionality taught by the present disclosure. It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an application specific integrated circuit (ASIC), because for large production runs the hardware implementation may be less expensive than the software implementation. Often a design may be developed and tested in a software form and later transformed, by well-known design rules, to an equivalent hardware implementation in an application specific integrated circuit that hardwires the instructions of the software. In the same manner as a machine controlled by a new ASIC is a particular machine or apparatus, likewise a computer that has been programmed and/or loaded with executable instructions may be viewed as a particular machine or apparatus.

Additionally, after the system 100 is turned on or booted, the CPU 102 may execute a computer program or application. For example, the CPU 102 may execute software or firmware stored in the ROM 106 or stored in the RAM 108. In some cases, on boot and/or when the application is initiated, the CPU 102 may copy the application or portions of the application from the secondary storage 104 to the RAM 108 or to memory space within the CPU 102 itself, and the CPU 102 may then execute instructions that the application is comprised of. In some cases, the CPU 102 may copy the application or portions of the application from memory accessed via the network connectivity devices 112 or via the I/O devices 110 to the RAM 108 or to memory space within the CPU 102, and the CPU 102 may then execute instructions that the application is comprised of. During execution, an application may load instructions into the CPU 102, for example load some of the instructions of the application into a cache of the CPU 102. In some contexts, an application that is executed may be said to configure the CPU 102 to do something, for example, to configure the CPU 102 to perform the function or functions promoted by the subject application. When the CPU 102 is configured in this way by the application, the CPU 102 becomes a specific purpose computer or a specific purpose machine.

The secondary storage 104 is typically comprised of one or more disk drives or tape drives and is used for non-volatile storage of data and as an over-flow data storage device if RAM 108 is not large enough to hold all working data. Secondary storage 104 may be used to store programs which are loaded into RAM 108 when such programs are selected for execution. The ROM 106 is used to store instructions and perhaps data which are read during program execution. ROM 106 is a non-volatile memory device which typically has a small memory capacity relative to the larger memory capacity of secondary storage 104. The RAM 108 is used to store volatile data and perhaps to store instructions. Access to both ROM 106 and RAM 108 is typically faster than to secondary storage 104. The secondary storage 104, the RAM 108, and/or the ROM 106 may be referred to in some contexts as computer readable storage media and/or non-transitory computer readable media.

I/O devices 110 may include cameras, printers, video monitors, liquid crystal displays (LCDs), plasma displays, touch screen displays, keyboards, keypads, switches, dials, mice, track balls, voice recognizers, card readers, paper tape readers, or other well-known input devices. The network connectivity devices 112 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WIMAX), near field communications (NFC), radio frequency identity (RFID), and/or other air interface protocol radio transceiver cards, and other well-known network devices. These network connectivity devices 112 may enable the processor 102 to communicate with the Internet or one or more intranets. With such a network connection, it is contemplated that the processor 102 might receive information from the network, or might output information to the network in the course of performing the above-described method steps. Such information, which is often represented as a sequence of instructions to be executed using processor 102, may be received from and outputted to the network, for example, in the form of a computer data signal embodied in a carrier wave. Such information, which may include data or instructions to be executed using processor 102 for example, may be received from and outputted to the network, for example, in the form of a computer data baseband signal or signal embodied in a carrier wave. The baseband signal or signal embedded in the carrier wave, or other types of signals currently used or hereafter developed, may be generated according to several methods well-known to one skilled in the art. The baseband signal and/or signal embedded in the carrier wave may be referred to in some contexts as a transitory signal.

The processor 102 executes instructions, codes, computer programs, scripts which it accesses from hard disk, floppy disk, optical disk (these various disk-based systems may all be considered secondary storage 104), flash drive, ROM 106, RAM 108, or the network connectivity devices 112. While only one processor 102 is shown, multiple processors may be present. Thus, while instructions may be discussed as executed by a processor, the instructions may be executed simultaneously, serially, or otherwise executed by one or multiple processors. Instructions, codes, computer programs, scripts, and/or data that may be accessed from the secondary storage 104, for example, hard drives, floppy disks, optical disks, and/or other device, the ROM 106, and/or the RAM 108 may be referred to in some contexts as non-transitory instructions and/or non-transitory information.

In an embodiment, the computer system 100 may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the computer system 100 to provide the functionality of a number of servers that is not directly bound to the number of computers in the computer system 100. For example, virtualization software may provide twenty virtual servers on four physical computers. In an embodiment, the functionality disclosed above may be provided by executing the application and/or applications in a cloud computing environment. Cloud computing may comprise providing computing services via a network connection using dynamically scalable computing resources. Cloud computing may be supported, at least in part, by virtualization software. A cloud computing environment may be established by an enterprise and/or may be hired on an as-needed basis from a third-party provider. Some cloud computing environments may comprise cloud computing resources owned and operated by the enterprise as well as cloud computing resources hired and/or leased from a third-party provider.

In an embodiment, some or all of the functionality disclosed above may be provided as a computer program product. The computer program product may comprise one or more computer readable storage medium having computer usable program code embodied therein to implement the functionality disclosed above. The computer program product may comprise data structures, executable instructions, and other computer usable program code. The computer program product may be embodied in removable computer storage media and/or non-removable computer storage media. The removable computer readable storage medium may comprise, without limitation, a paper tape, a magnetic tape, magnetic disk, an optical disk, a solid-state memory chip, for example analog magnetic tape, compact disk read only memory (CD-ROM) disks, floppy disks, jump drives, digital cards, multimedia cards, and others. The computer program product may be suitable for loading, by the computer system 100, at least portions of the contents of the computer program product to the secondary storage 104, to the ROM 106, to the RAM 108, and/or to other non-volatile memory and volatile memory of the computer system 100. The processor 102 may process the executable instructions and/or data structures in part by directly accessing the computer program product, for example by reading from a CD-ROM disk inserted into a disk drive peripheral of the computer system 100. Alternatively, the processor 102 may process the executable instructions and/or data structures by remotely accessing the computer program product, for example by downloading the executable instructions and/or data structures from a remote server through the network connectivity devices 112. The computer program product may comprise instructions that promote the loading and/or copying of data, data structures, files, and/or executable instructions to the secondary storage 104, to the ROM 106, to the RAM 108, and/or to other non-volatile memory and volatile memory of the computer system 100.

In some contexts, the secondary storage 104, the ROM 106, and the RAM 108 may be referred to as a non-transitory computer readable medium or a computer readable storage media. A dynamic RAM embodiment of the RAM 108, likewise, may be referred to as a non-transitory computer readable medium in that while the dynamic RAM receives electrical power and is operated in accordance with its design, for example during a period of time during which the computer system 100 is turned on and operational, the dynamic RAM stores information that is written to it. Similarly, the processor 102 may comprise an internal RAM, an internal ROM, a cache memory, and/or other internal non-transitory storage blocks, sections, or components that may be referred to in some contexts as non-transitory computer readable media or computer readable storage media.

### EXAMPLES

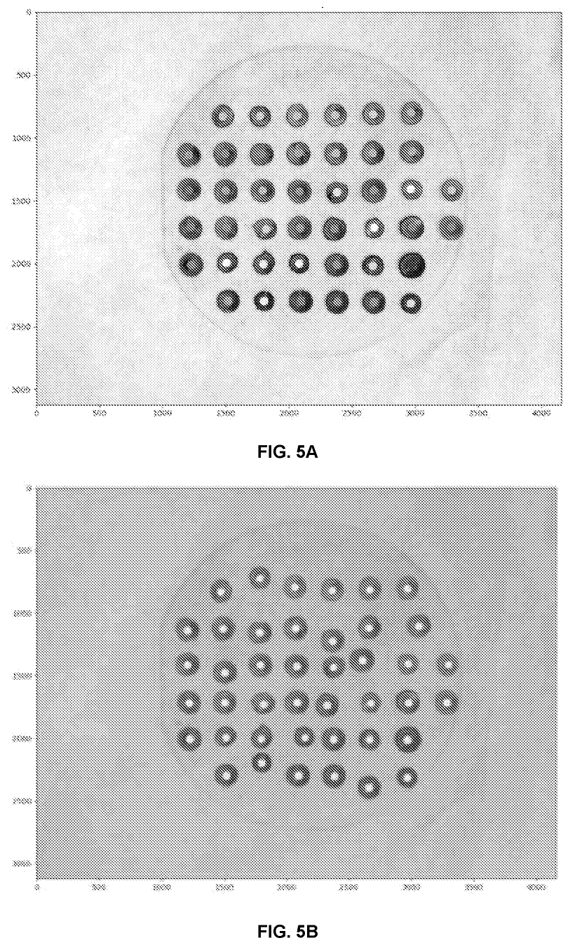

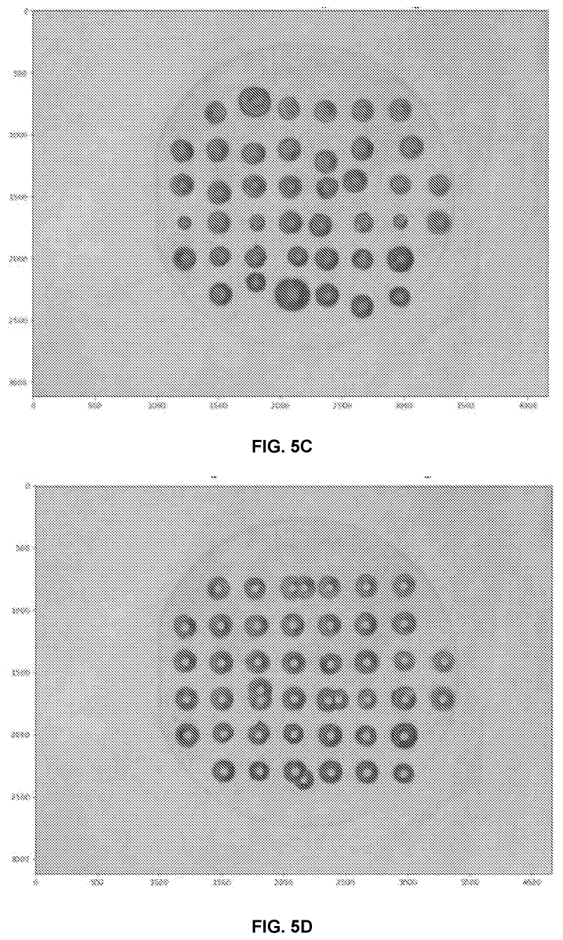

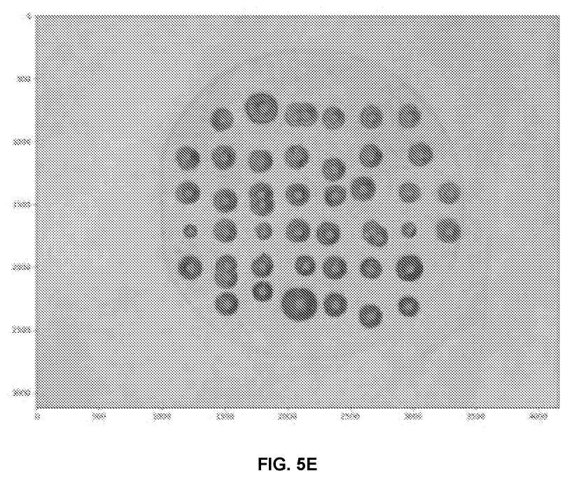

Referring now to FIGS. 5A through 5E, image recognition performed on dropcast films on a quartz wafer is shown. The image recognition performed on the dropcast films may be used to detect imperfect circles and retrieve centre coordinates for subsequent probe measurement. FIG. 5A is an image of the dropcast films on the quartz wafer, FIG. 5B shows misalignment errors, FIG. 5C shows size disparity, FIG. 5D shows droplet overlap and FIG. 5E shows all errors. As can be seen from FIGS. 5A through 5E, image recognition of the dropcast films may be used to identify sample variations during fabrication including misalignment, droplet overlap, size disparity, and a combination of imperfections. The data collection apparatus 10 easily identifies dropcast samples despite large variations during fabrication including misalignment, droplet overlap, size disparity, and combinations of errors. The minimum detectable feature size that can be measured by the probe 22 is 50 μm.

As is evident from the foregoing discussion, the present invention provides a modular translating probe station with image recognition for high-throughput measurements, for example, of more than 30 dropcast samples per hour. The modular platform with low-level machine intelligence of the present invention is greatly useful in reducing measurement time, troubleshooting time and error-rate in data collection. The low-level computer vision intelligence is used to identify different sample types, spatially index the sample arrays and perform the correct measurements. Advantageously, the low-level computer vision employed is robust against sample variation including misalignment, sample overlap, size disparity, and combinations of errors. The present invention provides synergistic advantages from computer vision and automated linear-translating probe techniques. The combination of high-precision probe methods and computer vision intelligence provides non-intuitive improvements in both techniques and enhances capabilities through autonomous operation. The present invention uses modularity of software and hardware to characterize variations in sample parameters from high-throughput synthesis. The 3-axis translation stage with a modular probe design allows different characterization probes to be used on arrays of samples and is reconfigurable for different measurement types. Further advantageously, the 50 μm spatial precision opens its usage to semiconductor device structures which vary on such length scales. The present invention does not require any reference points made on the sample or stage, instead recognizing an object based on its morphology. Accordingly, any generic wafer may be used with the data collection apparatus of the present invention and automatically identified without making a fiducial. The present invention is able to identify actual samples and recognize different parts of a sample. Defect identification may be performed with the present invention without pre-definition.

The data collection apparatus and the computer-implemented data collection method using the same may be applied in accelerated materials discovery for rapid characterization using various probe techniques and automated measurement.

While preferred embodiments of the invention have been described, it will be clear that the invention is not limited to the described embodiments only. Numerous modifications, changes, variations, substitutions and equivalents will be apparent to those skilled in the art without departing from the scope of the invention as described in the claims.

Further, unless the context clearly requires otherwise, throughout the description and the claims, the words “comprise”, “comprising” and the like are to be construed in an inclusive as opposed to an exclusive or exhaustive sense; that is to say, in the sense of “including, but not limited to”.

1. A data collection apparatus, comprising:
a first linear stage;
a sample carriage attached to the first linear stage, wherein the first linear stage is operable to move the sample carriage along a first axis;
a second linear stage;
a probe carriage attached to the second linear stage, wherein the second linear stage is operable to move the probe carriage along a second axis;
a third linear stage attached to the probe carriage, wherein, in use, the third linear stage is operable to receive a detachable characterisation probe and to move the characterisation probe along a third axis; and
a camera attached to the probe carriage, wherein, in use, the camera is configured to capture an image of one or more samples on the sample carriage.

2. The data collection apparatus according to claim 1, wherein each of the first, second and third linear stages is driven by a microstepper motor.

3. The data collection apparatus according to claim 2, wherein each of the first, second and third linear stages further comprises a plurality of linear bearings coupled to the microstepper motor by a pulley system.

4. The data collection apparatus according to claim 1, further comprising first and second optical endstops operable to determine real-time positions of the sample carriage and the probe carriage along the first and second axes, respectively.

5. The data collection apparatus according to claim 1, wherein the characterisation probe is one of an electrical probe and an electrochemical probe.

6. The data collection apparatus according to claim 5, wherein the electrical probe is one of a four-point probe and a Hall-effect probe.

7. The data collection apparatus according to claim 5, wherein the electrochemical probe is one of an ion-selective electrode and a magnetic probe.

8. The data collection apparatus according to claim 1, further comprising a non-transitory computer-readable memory storing computer program instructions executable by one or more computer processors to perform operations for data collection, the operations comprising:
capturing an image of the one or more samples using the camera;
performing image recognition on the captured image of the one or more samples to identify different sample types and spatially index sample arrays; and
performing measurements to characterise the one or more samples using the characterisation probe.

9. The data collection apparatus according to claim 8, wherein the operation of performing image recognition on the captured image comprises:
performing image registration on the captured image by detecting a sample substrate.

10. The data collection apparatus according to claim 9, wherein the operation of performing image recognition on the captured image comprises:
performing image thresholding on the captured image to binarize the captured image.

11. The data collection apparatus according to claim 10, wherein the operation of performing image recognition on the captured image comprises:
performing edge detection on the binarized image to identify sample boundaries.

12. The data collection apparatus according to claim 11, wherein the operation of performing image recognition on the captured image comprises:
performing blob detection on the binarized image to locate sample positions for subsequent measurements.

13. The data collection apparatus according to claim 12, wherein the operation of performing image recognition on the captured image comprises:
labelling the located sample positions.

14. A computer-implemented data collection method using the data collection apparatus of claim 1, comprising executing on one or more processors the steps of:
capturing an image of the one or more samples using the camera;
performing image recognition on the captured image of the one or more samples to identify different sample types and spatially index sample arrays; and
performing measurements to characterise the one or more samples using the characterisation probe.

15. The computer-implemented data collection method according to claim 14, wherein the step of performing image recognition on the captured image comprises:
performing image registration on the captured image by detecting a sample substrate.

16. The computer-implemented data collection method according to claim 15, wherein the step of performing image recognition on the captured image comprises:
performing image thresholding on the captured image to binarize the captured image.

17. The computer-implemented data collection method according to claim 16, wherein the step of performing image recognition on the captured image comprises:
performing edge detection on the binarized image to identify sample boundaries.

18. The computer-implemented data collection method according to claim 17, wherein the step of performing image recognition on the captured image comprises:
performing blob detection on the binarized image to locate sample positions for subsequent measurements.

19. The computer-implemented data collection method according to claim 18, wherein the step of performing image recognition on the captured image comprises:
labelling the located sample positions.
